(19) United States
(12) Patent Application Publication
(10) Pub. No.: US 2014/0162062 A1
(43) Pub. Date: Jun. 12, 2014

(54) RESISTANT CASING MIXTURE FOR CABLES AND LINES

(71) Applicant: NEXANS, Paris (FR)

(72) Inventors: Christain Cornelissen, Rodgau (DE); Armin Niehaus, GE Venlo (NL)

(21) Appl. No.: 14/041,007

(22) Filed: Sep. 30, 2013

(30) Foreign Application Priority Data
Oct. 2, 2012 (EP) 12 306 197.0

(51) Int. Cl. C08L 27/24

(52) U.S. Cl. CPC C08L 27/24
USPC 428/395; 524/447; 524/372; 524/322; 427/120

(57) ABSTRACT

A casing mixture for a line is provided, where the mixture is cross linked, and has as a polymer basis, chlorinated. polyethylene (CPE), chloroprene, in particular each having a chlorine content of 301-40% and a Mooney viscosity of about 80-105 Mooney units (Me) at 121° C. (38.1 mm rotor), or a mixture thereof, optionally with additional adhesion. promoters, and is distinguished by a content of fibers which are distributed in the mixture by a mixing procedure.

### RELATED APPLICATION

This application claims the benefit of priority from European Patent Application No. 12 306 197.0, filed on Oct. 2, 2012 the entirety of which is incorporated by reference.

### BACKGROUND

1. Field of the Invention

The invention relates to a casing mixture for cables and lines which, after cross linking, results in high strength vulcanized products, and which is particularly suitable for use as a casing mixture in lines and cables, particularly as a cross linked casing mixture for mechanically highly stressed cables, for example, mining cables and crane cables.

The casing mixture is composed on the basis of chlorinated polyethylene (CPE) and/or chloroprene as the cross linkable component and is distinguished by the fact that casings manufactured using the mixture have a high mechanical resistance, particularly a significantly higher Mod50-value or Mod200-value, which describes the force required for a 50% or 200% elongation of the mixture, as comparable compositions.

2. Description of Related Art

WO 2010/002878 describes an overland line which includes a tubular conductor arranged around a core of fiber reinforced polymer.

### OBJECTS AND SUMMARY

The object of the invention resides in making available a casing mixture on the basis of chloroprene and/or CPE which has a high mechanical load bearing capacity.

The invention meets this object with the features of the Claims and particularly with a casing mixture or a line which includes the cross linked casing mixture, particularly with an outer casing of the cross linked casing mixture. As the polymer basis, the casing mixture contains chlorinated polyethylene (CPE), chloroprene, particularly each having a chlorine content of 30%-40%, and with a respective Mooney viscosity of about 80-105 Mooney units (Me) at 121° C. (38.1 mm rotor) or a mixture thereof, optionally with an additional adhesion promoter, and is distinguished by the fact that it contains fibers which are distributed in the mixture by a mixing process. The casino mixture with the content of fibers can be used in a manufacturing process for cables or lines, particularly by extrusion onto a lower layer of the cable and by extrusion into a casing and by subsequently cross linking the mixture. Correspondingly, the invention also relates to a method of producing cables and lines in which the fiber containing casing mixture is shaped by extrusion into a casing and is cross linked. A particular advantage of this casing mixture resides in the fact that the mixture can be processed with a conventional extrusion process, that it results, after extrusion, in a sufficiently smooth and closed surface of the casing, and that it has a very high mechanical resistance, particularly for small deformations. Correspondingly, the polymer mixture is particularly suitable as a casing for cables and lines in the case of small deformations. Small deformations are, for example, torsion or circumferential expansion in the range of up to at most 100% on a path of 2 cm, for example, at a frequency of 1 to 60 min⁻¹, particularly up to 10 min⁻¹.

The casing mixture contains or consists of chloroprene and/or CPE or a mixture of chloroprene and/or CPE with at least one other cross linkable organic polymer with the indicated fillers and additives, particularly with non-polymerizable additives, for example processing aids and softeners, as well as a cross linking system which contains particularly a cross linking agent and/or a vulcanization accelerator, optionally a retarding agent and an activator (preferably ZnO), as well as adhesion promoters. Preferably, stablizers, anti-aging agents, optionally coloring agents, preferably with a brightener, are contained as added materials. Silica, preferably with a high specific surface area, is contained as filler. The high specific surface area of the silica is preferably at least 140 qm/g, particularly 160 qm/g, and fibers which are preferably synthetic fibers, particularly polyamide fibers, preferably having a diameter in the range of 10 μm to 100 μm. Preferably the fibers have an average length of 1 mm to 2 mm. The fibers can be processed dry as pulp fiber (consisting of dry fibers) or, after mixing a processing aid and/or an adhesion promoter into the mixture for example, may have a content of: 1%-3% maleic acid anhydride.

Preferably, the casing mixture contains

100 phr CPE and/or chloroprene,

stabilizer, for example magnesium oxide, particularly at 5 to 15 phr, preferably at 6-8 phr,

anti-aging agent, preferably at 1-7 phr, more preferred at 1-3 phr, particularly at 1-2 phr,

ozone protection agent, particularly at 1 phr,

mineral filler, for example, calcined or pyrogenous silicic acid, preferably at 25-35 phr, preferably at 30 phr,

hard kaolin, preferably at 45-55 phr, preferably at 50 phr,

coloring agent, for example, at a total of 3-6 phr, preferably 3-5 phr, optionally in mixture with another coloring agent, for example, at 0.8-1.6 phr, particularly at 1.2 phr,

softener, preferably phthalate at 20-45 phr, preferably at 20-30 phr, more preferred 22-24 phr,

processing agent (Struktol WB 222), for example at 1-3 phr, preferably 2 phr, and at 2-3 phr, preferably at 2.5 phr, for example, stearic acid and/or paraffin,

optionally adhesion promoters, for example, a functionalized poly-α-olefin (POE) grafted with 1%-3% by weight maleic acid anhydride particularly 2% to 3% by weight,

a starter system, for example, 2-3 phr co-activator in pulp fiber at, at least, 0.5 phr, preferably 1-4 phr, more preferred 1.5-2 phr, or consists thereof.

The portions indicated in the mixtures are to be expressed as phr (parts per hundred rubber), i.e., the weight portions of the components are referenced to 100 parts by weight polymer in the mixture.

After cross linking, the casing mixture according to the invention has good mechanical properties, in particular a high resistance against tensional and torsional loads.

Generally, it has been found that, compared to an otherwise identical mixture but without the fibers, the Mod50-value and the Mod200-value are significantly increased, for example, by 50% relative to the value for a fiber free comparison mixture.

Preferably, the fibers are synthetic polymer fibers, preferably of polyamide, particularly of aramid, for example, under the name Twaron or Keviar.

In an embodiment, the casing mixture does not contain adhesion promoters because it has been found that good strength values can be achieved even without adhesion promoters. In particular, the casing mixture has in the non-cross linked state a good processing capability, so that the process for manufacturing lines with a casing can be carried out using conventional kneaders and extruders.

Anti-aging agents may comprise or consist of, for example, pentaerythritol-bis (tetrahydrobenzaldehydacetal), particularly at 1-2 phr, preferably at 1.5 phr, anti-oxidants, particularly at 0.7-1.3 phr, preferably 1 phr, for example, a diphenyl compound, preferably at 2 phr.

Processing agents may comprise or consist of, for example, protective ozone wax, preferably at 3-6 phr, preferably 4 phr, for example, microcrystalline wax, paraffin, preferably at 4-8 phr, more preferred 5-7 phr, stearic acid, particularly up at 0-1 phr and/or silicon oil and mixtures thereof, in particular at a total of 8 to 15 phr.

The cross linking system may comprise or consist of, in particular, retarding agents, preferably at 0.9-1.5 phr, more preferred at 1.2 phr, for example, dibenzothiazldisulfide, cross linking agents and/or vulcanization accelerators, in particular at 0.95-1.55 phr, more preferred 1.25 phr, for example, N, N′-ethylenethiourea or 1.0-4.0 phr 3-methylthiazolidin-thion-2: (MTT) or 2,4,6-trimercapto-S-triadine (TCY) , cross linking/anti-aging agents, in particular at 1.4-2 phr, more preferred at 1.7 phr, for example, methylmercaptobenzimidazol contained in particular at 70% in elastomer bindings and dispergators, as well as activators, particularly 4-6 phr, preferably 5 phr, for example, ZnO and mixtures thereof.

For manufacturing the mixture, the components thereof are mixed, for example, in a kneader. The fibers can be added separately; preferably, the fibers are premixed together with a portion of the softener, optionally additionally with at least a portion of the adhesion promoter, and this mixture is added to the other components of the mixture.

After cross linking, the casing mixture according to the invention has a high resistance to torsional and/or tensional loads, wherein the content of fibers does not impair the electrical properties and the thermal and chemical resistance in comparison to a cross linked mixture which contains no fibers and is otherwise identical. The cross linking takes place preferably generally following the extrusion of the mixture at 150° C., particularly at 180° C. to 220° C. preferably at 200° C., and of at least 14 to 22 bars, preferably 20 bars. Cross linking preferably takes place for a duration of tc90×1.4 to 2, particularly for tc90×1.4; in this connection tc90 refers to the time of reaching 90% of the maximum of the cross linking isothermals.

### DETAILED DESCRIPTION

The casing mixture according to the invention will now be described with the aid of example mixtures and their mechanical properties, particularly their high mechanical resistance.

Table 1 shows mixtures according to the invention. The mixture components were mixed in a standard cycle in a stage in a 2.9L laboratory kneader with a tangential rotor system and a filling factor of 60%-80%; the mixture is then shaped. into test plates and then by heating to 180° C. at a hydraulic pressure of 230 bars which is applied onto the heated die for tc90×1.4 min. The tc90 value is picked up from the rheometer curve.

TABLE 1
Mixture According to the Invention and Comparative
Mixture

| | | Mixture |
|---|---|---|
| | Comparative | According to |
| Component (phr) | Mixture | Invention |
| CPE | 100 | 100 |
| Stabilizer (MgO) | 7 | 7 |
| Anti-aging Agent | 2 | 2 |
| Filler (silicic acid) | 30 | 30 |
| Hard kaolin | 50 | 50 |
| Coloring Agent | 5.2 | 5.2 |
| Softener (Phthalate Softener) | 43 | 23 |
| Processing Agents (Protective | 4.5 | 4.5 |
| Ozone Wax, Paraffin, Stearic | | |
| Acid) | | |
| Adhesion Promoter (with 3% by | 1.5 | 0 |
| weight Maleic Acid grafted PE) | | |
| Starter system | 10.4 | 10.4 |
| Fiber (Aramid) | 0 | 3 |

The aramid fibers had a median length of about 2 mm and a diameter of 0.2 mm-4 mm.

A measurement of the load. bearing capacity according to EN 60811-1-1 for the force to be applied to the surface area with 200% elongation of the cross linked test strip resulted for the mixture in, according to the invention, a 0od200-value of 5.7 MPa and for the comparative mixture in a Mod200-value of <MPa which is significantly lower.

When adding adhesion promoters to the mixture according to the invention, the Mod200-values increased, even further.

1. Polymer mixture for electrical and/or optical cables and lines, said mixture comprising:
100 phr CPE and/or chloroprene,
5 to 10 phr stabilizer,
1 to 7 phr anti-aging agent, -ozone protection agent,
25 to 35 phr mineral filler,
45 to 55 phr hard kaolin,
coloring agent,
20 to 45 phr softener,
processing aids,
0 to 1.5 phr adhesion promoter,
a starter system; and
at least 0.5 phr synthetic fibers.

2. Polymer mixture according to claim 1, wherein the mineral filler is either one of calcined or pyrogenous silicic acid.

3. Polymer mixture according to claim 1, wherein the fibers have a median length of 1.5 mm to 3 mm and are dispersed in the polymer mixture.

4. Polymer mixture according to claim 1, wherein the stabilizer is MgO, the anti-aging agent is pentaerythritol-bis (tetrahydrobenzaldehydacetal), a diphenyl compound, and the cross linking system includes any one of the group consisting of a retarder, a cross linking agent, a vulcanization accelerator and an activator.

5. Polymer mixture according to claim 1, wherein the adhesion promoter is a functionalized polymer.

6. Polymer mixture according to claim 1, wherein the processing aid is a mixture of any one of ozone protective wax, paraffin, stearic acid or silicon oil.

7. Polymer mixture according to claim 1, wherein the mixture consists of:
100 phr CPE and/or chloroprene,
5 to 10 phr stabilizer,
1 to 7 phr anti-aging agent, -ozone protection agent,
25 to 35 phr mineral filler,
45 to 55 phr hard kaolin,
coloring agent,
20-45 phr softener,
processing aid,
0 to 1.5 phr adhesion promoter,
a starter system,
at least 0.5 phr synthetic fibers.

8. Polymer mixture according to claim 1, wherein said mixture has, after cross linking, a Mod50-value of at least 2 MPa and a Mod200-value of at least 5 MPa.

9. Polymer mixture according to claim 1, wherein the synthetic fibers are aramid fibers having an average length of 1.5 mm to 3 mm.

10. An Electrical, optical or electrical/optical line or cable, wherein said line or cable has an outer casing of a cross linked polymer mixture according to claim 1.

11. The line or cable according to claim 10, wherein the casing is subjected to a torsional load at angles of 2° to at most 20°.

12. A Method for manufacturing a line or a cable, said method comprising the steps of:
mixing components of a polymer mixture;
extruding said polymer mixture around at least one electrical and/or optical conductor; and
cross linking the polymer mixture,
wherein the polymer mixture is in accordance with claim 1.

13. Method according to claim 12, wherein the mixture is extruded toward. a casing of the line or cable and is cross linked by heating.

14. Method according to claims 13, wherein heating is carried out up to 150° C. to 220° C. at a vapor pressure of up to 14 bars to 22 bars.

15. Polymer mixture according to claim 5, wherein the adhesion promoter is a poly-α-olefin.
